(19) United States
(12) Patent Application Publication
(10) Pub. No.: US 2024/0098102 A1
(43) Pub. Date: Mar. 21, 2024

(54) SOCIAL GRAPH ENABLED LATERAL MOVEMENT DETECTION

(71) Applicant: Meta Platforms, Inc., Menlo Park, CA (US)

(72) Inventor: Brandon Sloane, Lancaster, SC (US)

(73) Assignee: Meta Platforms, Inc., Menlo Park, CA (US)

(21) Appl. No.: 17/823,792

(22) Filed: Aug. 31, 2022

(51) Int. Cl. H04L 9/40

(52) U.S. Cl. CPC H04L 63/1425; H04L 63/0227; H04L 63/1416; H04L 63/20

(57) ABSTRACT

Disclosed technology herein provides for generating a network traffic map, using a social graph algorithm, based on a first set of network traffic data captured in a first time frame, storing map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment. Network traffic data can include data representing a transaction duration and/or a volume of data transferred. In embodiments, map data from the network traffic map is stored in individual nodes and aggregated centrally, and peer-to-peer validation is conducted on map data from the network traffic map.

### TECHNICAL FIELD

Embodiments generally relate to computing systems. More particularly, embodiments relate to detection of unauthorized network activity within a networked computing infrastructure.

### BACKGROUND

With any enterprise, it is difficult to prevent adversaries from obtaining a foothold within a networked environment. Instead, it is assumed that a breach has occurred (or can occur), and the task turns to detecting unauthorized activity within the network. This is an extremely challenging problem to solve. For example, how to determine whether communication between two devices falls into the category of authorized, and what heuristics can be applied to help distill legitimate traffic from adversarial traffic, are two of many questions without good answers. While there are a number of tools and processes that look at network traffic patterns and attempt to draw conclusions based on specific observed ports or even historical traffic patterns, these do not provide reliable solutions to the security risks presented.

### SUMMARY OF PARTICULAR EMBODIMENTS

In accordance with one or more embodiments, a computer-implemented method includes generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

In accordance with one or more embodiments, a computing system includes a processor, and a memory coupled to the processor, the memory including instructions which, when executed by the processor, cause the computing system to perform operations including generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

In accordance with one or more embodiments, at least one computer readable storage medium includes a set of instructions which, when executed by a computing device, cause the computing device to perform operations including generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram illustrating an example of a networked infrastructure environment for lateral movement detection according to one or more embodiments;

FIG. 2 is a block diagram illustrating an example of a lateral movement detection system according to one or more embodiments;

FIG. 3A is a block diagram illustrating aspects of an example social graph generator according to one or more embodiments;

FIGS. 3B-3C provide diagrams illustrating examples of traffic maps according to one or more embodiments;

FIG. 4A is a block diagram illustrating aspects of an example comparison engine according to one or more embodiments;

FIG. 4B is a block diagram illustrating aspects of an example policy engine according to one or more embodiments;

FIG. 5 is a block diagram illustrating aspects of an example dashboard and reporting interface according to one or more embodiments;

FIG. 6 is a block diagram illustrating aspects of an example integration module according to one or more embodiments;

FIG. 7 is a flow diagram illustrating an example of a method of detecting lateral movement according to one or more embodiments; and

FIG. 8 is a block diagram illustrating a computing system for use in a lateral movement detection system according to one or more embodiments.

### DESCRIPTION OF EMBODIMENTS

The technology as described herein provides an improved computing system to detect lateral movement for determining unauthorized network activity. Using social graph algorithms to construct maps for network nodes, the technology helps improve the overall network security by evaluating the riskiness of network traffic based on, e.g., the relative closeness of new traffic to anticipated traffic using these constructed maps and determining appropriate remediation strategies.

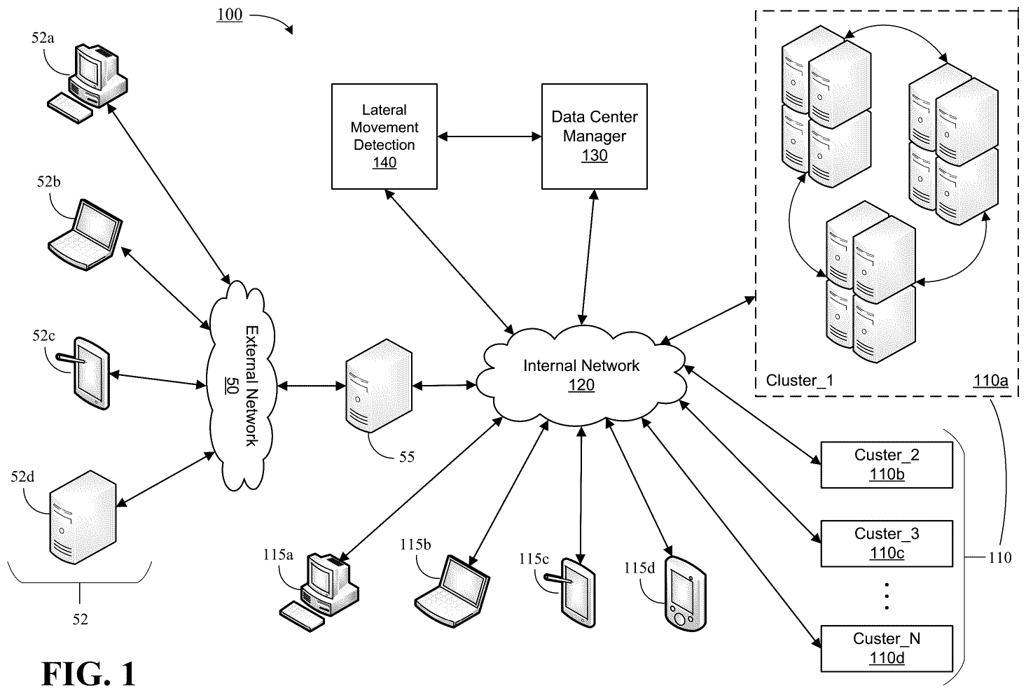

FIG. 1 provides a block diagram illustrating an example of a networked infrastructure environment 100 for lateral movement detection according to one or more embodiments, with reference to components and features described herein including but not limited to the figures and associated description. As shown in FIG. 1, the networked infrastructure environment 100 includes an external network 50, a plurality of external user or client devices 52 (such as example external client devices 52a-52d), a network server 55, a plurality of server clusters 110 (such as example clusters 110a-110d), a plurality of internal user or client devices 115 (such as example internal client devices 115a-115d), an internal network 120, a data center manager 130, and a lateral movement detection system 140. The external network 50 is a public (or public-facing) network, such as the Internet. The client devices 52a-52d are devices that communicate over a computer network (such as the Internet) and can include devices such as a desktop computer, laptop computer, tablet, mobile phone (e.g., smart phone), etc. The client devices 52a-52d can operate in a networked environment and run application software, such as a web browser, to facilitate networked communications and interaction with other remote computing systems, including one or more servers, using logical connections via the external network 50.

The network server 55 is a computing device that operates to provide communication and facilitate interactive services between users (such as via client devices 52a-52d) and services hosted within a networked infrastructure via other servers, such as servers in clusters. For example, the network server 55 can operate as an edge server or a web server. In embodiments, the network server 55 is representative of a set of servers that can range in the tens, hundreds or thousands of servers. The networked services can include services and applications provided to thousands, hundreds of thousands or even millions of users, including, e.g., social media, social networking, media and content, communications, banking and financial services, virtual/augmented reality, etc.

The networked services can be hosted via servers, which in embodiments can be grouped in one or more server clusters 110 such as, e.g., one or more of Cluster_1 (110a), Cluster_2 (110b), Cluster_3 (110c) through Cluster_N (110d). The servers/clusters are sometimes referred to herein as fleet servers or fleet computing devices. Each server cluster 110 corresponds to a group of servers that can range in the tens, hundreds or thousands of servers. In embodiments, a fleet can include millions of servers and other devices spread across multiple regions and fault domains. In embodiments, each of these servers can share a database or can have their own database (not shown in FIG. 1) that warehouse (e.g. store) information. Server clusters and databases can each be a distributed computing environment encompassing multiple computing devices, and can be located at the same or at geographically disparate physical locations. Fleet servers, such as the servers in clusters 110, can be networked via the internal network 120 and managed via a data center manager 130.

The client devices 115a-115d are devices that communicate over a computer network (such as the internal network 120) and can include devices such as a desktop computer, laptop computer, tablet, mobile phone (e.g., smart phone), etc. The client devices 115a-115d can operate in a networked environment and run application software, such as a web browser, to facilitate networked communications and interaction with other devices in the networked environment using logical connections via the internal network 120, and can further interact with remote computing systems, including one or more client devices or servers, using logical connections via the external network 50.

The networked environment can be at risk for unauthorized activity within the network. To help address the security risks posed by unauthorized network activity, the lateral movement detection system 140 is provided to detect lateral movement for determining unauthorized network activity. As described further herein, the lateral movement detection system 140 operates to construct maps for network nodes using social graph algorithms, determine changes from anticipated network traffic to identify likelihood of risky traffic, and determine appropriate remediation.

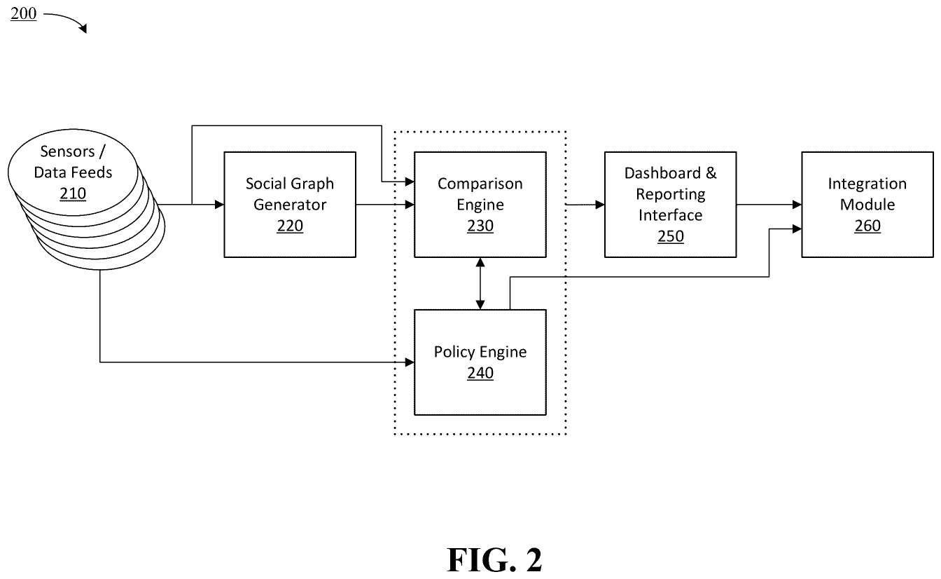

FIG. 2 provides a block diagram illustrating an example of a lateral movement detection system 200 according to one or more embodiments, with reference to components and features described herein including but not limited to the figures and associated description. In embodiments, the lateral movement detection system 200 corresponds to the lateral movement detection system 140 (FIG. 1, already discussed). As shown in FIG. 2, in embodiments the system 200 includes sensors and data feeds 210, a social graph generator 220, a comparison engine 230, a policy engine 240, a dashboard and reporting interface 250, and an integration module 260. The sensors and data feeds 210 provide network traffic data and include, in some embodiments, individual software sensors (node sensors) placed on each node in the network (or at least on a plurality of nodes in the network). Nodes in the network can include any one or more of the devices shown in the networked infrastructure environment 100, and can include other networked devices or components not shown in FIG. 1 (e.g., routers, switches, etc.). Nodes can include any devices in communication in the network, e.g., any devices having an internet protocol (IP) address or a media access control (MAC) address. Nodes can be organized in zones or layers in the network.

In some embodiments, the sensors and data feeds 210 include sensors on devices at the network layer such as, e.g., routers and switches. In some embodiments, the sensors and data feeds 210 include software sensors on nodes or on network layer devices which act as a collection agent for network layer traffic. In some embodiments, the sensors and data feeds 210 include one or more feeds from existing network sensing and data collection system(s). In embodiments, the sensors and data feeds 210 include a plurality of or all of the foregoing components. Key data elements collected and/or received from the sensors and data feeds 210 can include uniquely identifiable node information such as, e.g., network hardware addressing, routing information, and various metadata from network traffic transmissions.

In embodiments, network traffic data is collected for every node in the network. Collection of network traffic data varies, in embodiments, based on the type or class of node. For example, mobile devices are, in some embodiments, subject to collection of higher detail of network traffic. For example, in embodiments more detailed traffic data is collected for certain classes of nodes such as, e.g., nodes (devices) for administration users, nodes (devices) for known high-risk users, etc., nodes (devices) for all employees, etc. In embodiments, traffic data collected depends on network topology, node location, etc. For example, nodes in foreign jurisdictions are, in some embodiments, subject to collection of higher detail of network traffic.

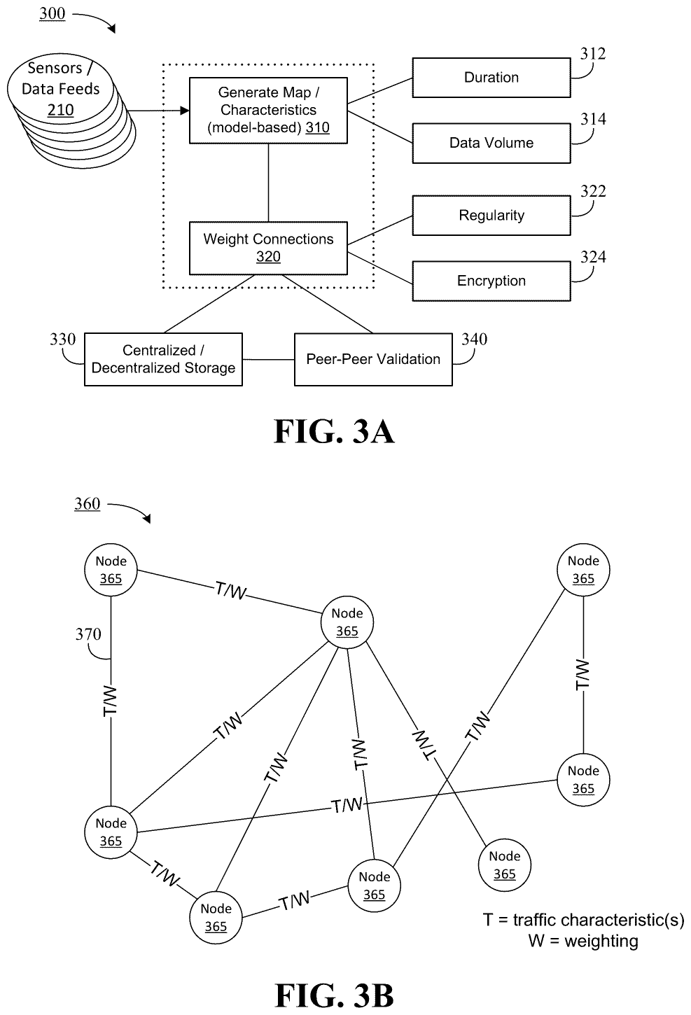

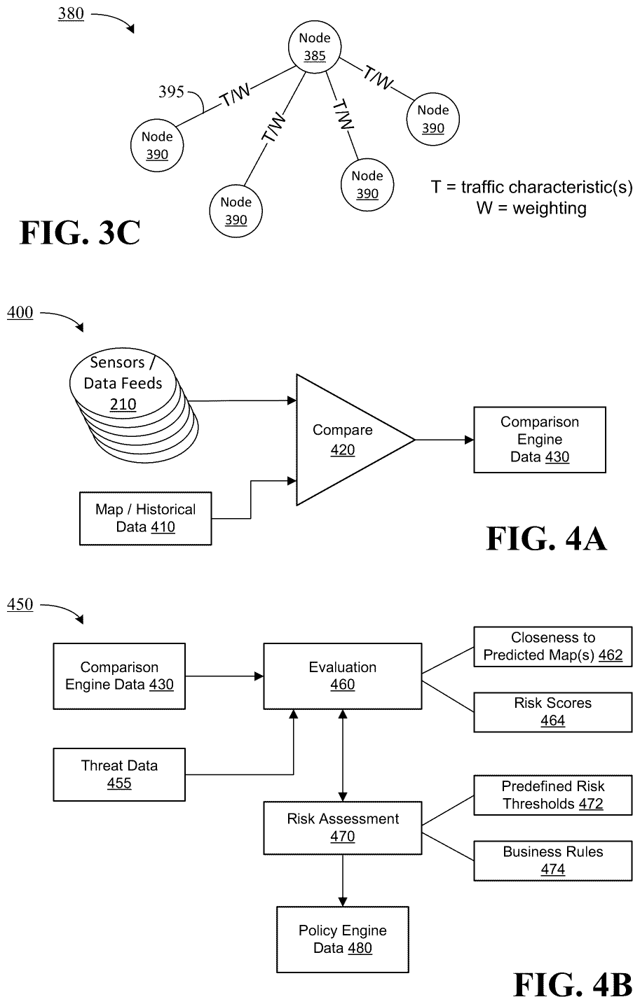

The social graph generator 220 utilizes and builds upon existing social graphing algorithms to generate, for each node, a unique map (e.g., graph) of other nodes relating to that specific node being mapped. In some embodiments, social graphing algorithms leverage measures of network centrality including but not limited to one or more of the degrees for each particular node, measures of closeness to other nodes on the graph (e.g., number of network hops required between those nodes), measures of betweenness to other nodes on the graph (e.g., latency between nodes), etc. or more advanced mathematical representations such as, e.g., EigenVector or measures of iterative circles. These maps (e.g., graphs) are generated based on the network traffic provided by the sensors and data feeds 210, and provide information on relationships between nodes. Further details regarding the social graph generator 220 are described herein with reference to FIGS. 3A-3C.

The comparison engine 230 operates to compare observed data traffic and anticipated or predicted network traffic behavior, providing a state of the network. Observed data traffic can be provided by the sensors and data feeds 210, and anticipated or predicted network traffic behavior can be based on the maps (e.g., graphs) generated by the social graph generator 220. The policy engine 240 operates in conjunction with the comparison engine 230 to evaluate the differences in observed data traffic and anticipated or predicted network traffic behavior (e.g., from the comparison engine 230) and providing a risk assessment (e.g., likelihood of risky traffic). In some embodiments, the comparison engine 230 and the policy engine 240 are integrated into a single engine or module. Further details regarding the comparison engine 230 and the policy engine 240 are described herein with reference to FIGS. 4A-4B.

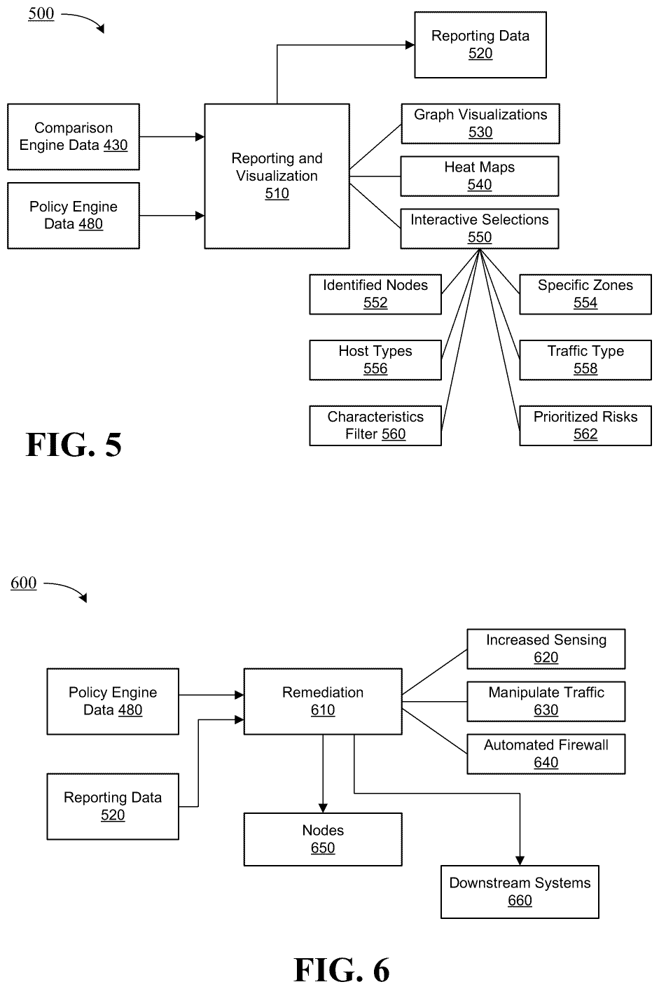

The dashboard and reporting interface 250 provides reporting information to users regarding the state of the network (from the comparison engine 230) and risk assessment (from the policy engine 240). Additionally, the dashboard and reporting interface 250 provides visualization of the network information as well as interactive selectivity for reporting and visualization. Further details regarding the dashboard and reporting interface 250 are described herein with reference to FIG. 5.

The integration module 260 provides for remediation of potential network risks identified by the policy engine 240 and based on the reporting information from the dashboard and reporting interface 250. Remediation can be applied not only to network elements (e.g., network nodes) but also provided to downstream systems to impact downstream activity. Further details regarding the integration module 260 are described herein with reference to FIG. 6.

Some or all components in the system 200 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 200 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 200 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3A provides a block diagram illustrating aspects of an example social graph generator 300 according to one or more embodiments, with reference to components and features described herein including but not limited to the figures and associated description. In embodiments, the social graph generator 300 corresponds to the social graph generator 220 (FIG. 2, already discussed). The social graph generator receives network traffic data from the sensors and data feeds 210 (e.g., network traffic data captured in a first time frame) and operates to generate, using social graph algorithms, one or more maps (e.g., graphs) for each node (block 310). As such, the social graph generator 220 operates to normalize and organize the network traffic data, and provide for historic data e.g., in the form of stored maps. The maps provide information about relationships between nodes that can have various magnitudes/strengths and characteristics.

Maps can be generated flexibly based on a variety of desired insights (e.g., based on models of network behavior) and can be evidence-based or outcome-based. Characteristics regarding node relationships can include one or more aspects such as, e.g., transaction or session duration (block 312) and/or volume of data transferred (block 314). Strength variation can be applied as a weighting to node connections (block 320), which can include one or more aspects such as, e.g., regularity (block 322), such as how regular are connections occurring between particular nodes, and/or encryption of traffic between nodes (block 324). For example, greater weighting can be applied to connections which occur more regularly or to connections that are historically encrypted. In embodiments, different weighting is applied based on the kind of map or map characteristics (e.g., providing various perspectives). In embodiments, multiple maps are generated for one or more nodes depending on traffic characteristics, and such maps can represent different desired outcomes as represented, e.g., by differences in magnitudes or characteristics.

In some embodiments mapping varies across different nodes based on different classes of nodes and relative importance of those nodes. For example, in a trusted resource zone for critical systems, the system 200 can gather extremely detailed network traffic information and construct very elaborate graphs. In some embodiments, these graphs might contain and or leverage detailed information about both the nature and context of transactions between nodes including but not limited to different classes of application layer traffic, port information, encryption algorithm information, user authentication protocols, authentication transaction information, and even application session information such as specific commands issued or data transferred. By contrast, in more general network segments, the system can be designed to only capture generic metadata around transmission information.

In embodiments, generated map data (or at least a portion thereof) is stored in a centralized or decentralized fashion, depending on defined traffic data and characteristics to be collected and fed into the mapping algorithms (block 330). For example, in embodiments generated map data (or at least a portion thereof) is stored in a centralized database for use by the lateral movement detection system 200 and/or by another command/control system in the networked environment (such as, e.g., the data center manager 130). Thus, in embodiments with fully or primarily centralized map generation and storage, network data traffic collected at nodes is passed to a central resource (e.g., the lateral movement detection system 200), which handles map generation, behavioral analysis and remediation. In embodiments, generated map data (or at least a portion thereof) is stored in a decentralized manner such as, e.g., in the individual nodes, and map data is generated on these individual nodes to be queried by the lateral movement detection system 200 and/or by another command/control system. Thus, in embodiments with fully or primarily decentralized map generation and storage, network data traffic collected at nodes is stored (map generation) via local resources, which handles map generation and (local) network behavioral analysis. Remediation can occur locally, or network behavioral events can be reported to a central resource (e.g., the lateral movement detection system 200) for further analysis, aggregation and remediation.

In embodiments, a hybrid arrangement includes both centralized and decentralized storage, where data is first gathered on decentralized individual nodes, where initial maps are constructed, and then the data and maps are aggregated centrally for use by the lateral movement detection system 200 and/or by another command/control system. In some hybrid embodiments, aspects of behavioral analysis are conducted or processed locally (e.g., to examine peer-to-peer behavior) and reported to a central resource (e.g., the lateral movement detection system 200) for further network analysis (including, e.g., graph aggregations) and remediation.

In embodiments with high degrees of individual node activity and traffic, a decentralized data storage and map generation implementation provides preprocessing capabilities as part of graph generation. For example, node contextual graph generation can take into consideration factors such as the type or function of a particular node. Thus, different nodes make different decisions regarding the types of traffic monitored/prioritized for collection or the types of graphs to be generated therefrom. As one example, nodes operating as a critical resource can prioritize certain types of network traffic (e.g., domain controller traffic) and/or traffic having critical confidentiality or security features. Other nodes can deemphasize certain types of traffic that would be rarely seen by that node. In embodiments with more interconnectedness and relative importance on contextual representation of traffic data as they pertain to other nodes, a centralized data storage and map generation implementation provides greater opportunities for constructing relatedness measurements between transactional graph representations.

In embodiments, peer-to-peer validation is conducted (e.g., performed) as an integrity check on the generated maps (block 340) for decentralized map data storage. For example, peer nodes make requests to each other for their respective maps and then validate whether the peer node maps reflect what the requesting node perceives to be an accurate representation of the traffic patterns of that requesting node. In cases where there is a potential mapping integrity issue, an alert can be generated and sent to the system 200 for remediation. In embodiments, remediation actions include the issuance of commands to a particular node or set of nodes including but not limited to, one or more of regenerating map representations, reassembling underlying map data, ignoring certain aspects of a map or map data, or designating certain aspects of a map or map data as authoritative and overwriting other aspects of a map or map data on other nodes. In embodiments, validation reports (including successful validation) can be provided to the system 200.

Some or all aspects of the social graph generator 300 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the social graph generator 300 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the social graph generator 300 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3B provides a diagram illustrating an example of a traffic map 360 (e.g., graph) generated by the social graph generator 300 according to one or more embodiments, with reference to components and features described herein including but not limited to the figures and associated description. The map 360 is based on aggregated map data from a plurality of nodes 365 having edges 370 representing connections between nodes 365 based on collected traffic data. The edges 370 include traffic characteristics T (e.g., characteristics per block 310) and weighting W (e.g., weighted connections per block 320).

Edges provide a multi-dimensional characterization relationship (e.g., traffic) between any two nodes. For example, characterizations of network traffic between nodes can include one or more of the following: network port, application, encryption (or lack of encryption), session duration, quantity of data transferred, historical relationship (e.g., routine or common interactions, rarity, etc.), time, location, etc. In embodiments, characteristics tracked over time for traffic between nodes can be modified based, e.g., on machine learning to determine which characteristics provide impactful information regarding network security and threat assessment.

The map 360 is constructed, e.g., based on map data or maps generated for individual nodes 365 (such as, e.g., illustrated in FIG. 3C). In embodiments, the graph can map network interactions based on applications or sessions. In embodiments, the social graph generator 300 can map network interactions based on layer in the open systems intercommunication (OSI) stack such as, e.g., session layer, transport layer, etc. In embodiments, application layer interactions include but are not limited to one or more of authentication, issuance of application commands, transfer/retrieval or modification of data. In embodiments, network layer interactions include but are not limited to one or more of ports utilized, services running, network encryption protocols, subnet information, route information, hops, latency, or packet information.

In some embodiments, mapping provides multiple edges between nodes. For example, in some embodiments each transaction between nodes results in a separate edge. As an example for such embodiments, if a user with a laptop connects to an e-mail server, each download or upload of emails between the laptop and e-mail server results in a separate edge. In other embodiments, an edge represents multiple transactions between nodes. As an example for such other embodiments, if a user with a laptop connects to an e-mail server, multiple downloads and uploads of emails (e.g., within the time frame for collecting the current network traffic) between the laptop and e-mail server results in a single edge representing interaction details for multiple transactions.

FIG. 3C provides a diagram illustrating an example of a traffic map 380 (e.g., graph) generated by the social graph generator 300 according to one or more embodiments, with reference to components and features described herein including but not limited to the figures and associated description. The map 380 is based on map data from a node 385 relating to its neighboring nodes 390, with edges 395 representing connections between node 385 and the neighbor nodes 390 based on collected traffic data. The edges 395 include traffic characteristics (e.g., characteristics per block 310) and weighting (e.g., weighted connections per block 320).

FIG. 4A provides a block diagram illustrating aspects of an example comparison engine 400 according to one or more embodiments, with reference to components and features described herein including but not limited to the figures and associated description. In embodiments, the comparison engine 400 corresponds to the comparison engine 230 (FIG. 2, already discussed). The comparison engine 400 receives input network traffic data from the sensors and data feeds 210 (e.g., current network traffic), as well as map data 410 (graph data) from the social graph generator 300 (e.g., the social graph generator 220). In embodiments the map data 410 includes historical network traffic data, which can encompass, or be used to generate, anticipated or predicted network traffic behavior. The comparison engine 400 determines (block 420) differences between the input network traffic (e.g., current network traffic) from the sensors and data feeds 210 and the historical network traffic data to identify potential anomalies, discrepancies or departures from expected network behavior. Output comparison engine data 430 is generated by the comparison engine 400 for use by other components of the system 200, e.g., by the policy engine 240 (FIG. 2, already discussed) and/or the dashboard and reporting interface 250 (FIG. 2, already discussed). In embodiments, newly captured traffic data (e.g., as input to the comparison engine 400 for comparing to historic or prior map data) is used to update the map data 410 and/or to generate new maps.

Some or all aspects of the comparison engine 400 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the comparison engine 400 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the comparison engine 400 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4B provides a block diagram illustrating aspects of an example policy engine 450 according to one or more embodiments, with reference to components and features described herein including but not limited to the figures and associated description. In embodiments, the policy engine 450 corresponds to the policy engine 240 (FIG. 2, already discussed). The policy engine 450 receives as input the comparison engine data 430 (e.g., potential anomalies, discrepancies or departures from expected network behavior determined by the comparison engine 400). In some embodiments the policy engine 450 also receives as input threat data 455 from other threat intelligence systems or risk engines.

The policy engine 450 provides a metric for evaluating the input information (block 460) including, e.g., a relative closeness of the actual (i.e., observed) network behavior (e.g., network traffic data captured in a second time frame) to predicted or anticipated maps/behavior (block 462) and/or establishing a risk score for riskiness of the observed behavior (block 464). In embodiments the risk scores are based on one or more risk factors indicating, for example, the likelihood of including adversarial data transmission (data movement), the likelihood of unauthorized access (access management), and/or the likelihood of scanning or discovery activity (enumeration), etc. As such, the risk score provides a multi-dimensional evaluation of the observed vs predicted behavior (and, when present, threat data). In some embodiments, each of these risk factors is weighted to provide an integrated risk score within a broader risk framework. In some embodiments, the policy engine 450 defines metrics, based e.g. on threat 455, for use in evaluating the comparison engine data 430.

Based on the evaluation (including risk scores), the policy engine 450 provides a risk assessment (block 470) detailing, for example, the likelihood of risky traffic. The risk assessment is provided as output policy engine data 480. In some embodiments the risk assessment is based on (or aided by) predefined risk thresholds (block 472). As one example, the risk assessment block 470 can ascribe a high risk value to traffic occurring outside the window of normal operating hours, where that risk value exceeds the predefined risk threshold 472 based on only medium risk traffic allowable between two particular nodes or sets of nodes. If the observed traffic has a risk score below this particular threshold, such as, e.g., the traffic occurs within the window of normal operating hours to which the risk assessment block 470 ascribes a low risk value, that risk falls within the predefined risk threshold 472 of only medium risk traffic allowable. In some embodiments the risk assessment is based on (or aided by) business rules (block 474), such as, e.g., a business rule which states that traffic between two particular nodes and or sets of nodes should never occur in an unencrypted state. In some embodiments, both predefined risk thresholds and business rules are used in providing the risk assessment.

Some or all aspects of the policy engine 450 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the policy engine 450 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the policy engine 450 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 5 provides a block diagram illustrating aspects of an example dashboard and reporting interface 500 according to one or more embodiments, with reference to components and features described herein including but not limited to the figures and associated description. In embodiments, the dashboard and reporting interface 500 corresponds to the dashboard and reporting interface 250 (FIG. 2, already discussed). The dashboard and reporting interface 500 provides reporting information and visualization (block 510) to users regarding the network status based on the comparison engine data 430 (from the comparison engine 400) and risk assessment based on the policy engine data 430 (from the policy engine 450). Reporting information is provided as output reporting data 520.

Visualizations provided by the dashboard and reporting interface 500 include one or more of graph visualizations (block 530), heat maps (block 540), etc. Graph visualizations such as, e.g., display of network traffic graphs, and heat maps such as, e.g., maps showing high risk traffic patterns and locations, are used to draw attention to suspicious network activity. Interactive components enable system operators to enter selections (block 550) to focus on particular elements or highlight particular types of activity, for use in providing reporting data and/or visualizations. For example, interactive selections enable highlighting (including, e.g., focus or isolation) or of one or more of identified nodes (block 552), specific zones (block 554), host types or network segments (block 556), traffic type (block 558), etc. Additionally, interactive selections enable filtering of network traffic data across any number of different traffic characteristics (block 560), and/or prioritizing different types of observed network behavior (e.g., riskiness)(block 562). Interactive selections are provided, e.g., via an interactive user interface.

Some or all aspects of the dashboard and reporting interface 500 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the dashboard and reporting interface 500 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the dashboard and reporting interface 500 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 6 provides a block diagram illustrating aspects of an example integration module 600 according to one or more embodiments, with reference to components and features described herein including but not limited to the figures and associated description. In embodiments, the integration module 600 corresponds to the integration module 260 (FIG. 2, already discussed). The integration module 600 takes input data, such as the policy engine data 480 (e.g., risk assessment) and/or the reporting data 520 (e.g., network status), and provides automated decisioning and remediation determination (block 610). In embodiments, remediation determinations include taking further actions such as, for example, increased observation and sensing activity via, e.g., node sensors (such as node sensors in sensors and data feeds 210) (block 620), direct manipulation of network traffic and/or routing behavior (block 630), etc. As another example, in embodiments an automated firewall rule (block 640) is invoked to block or cut off traffic to and from a particular node pending further investigation or resolution of an alert. In embodiments such an alert is triggered by observed risky network behavior that, for example, exceeds policy engine rules for a defined threshold and/or deviates considerably (e.g., more than a threshold) from a map for a particular node. In some embodiments, in response to a detected potential threat, other remediation actions include one or more of the following: tracking calls to an external source; tracking hops between internal servers.

Remediation actions such as those described for blocks 620, 630 and/or 640 are, in embodiments, directed to the impacted node(s) 650. For example, in embodiments remediation efforts are tuned based on the level of mapping detail or characteristics of network traffic. As an example, increases in sensing activity (block 620) are based on the level of traffic information available from constructed maps for a given node. Additionally, in some embodiments, the integration module 600 provides decisioning and remediation to be implemented in downstream systems (block 660). For example, the integration module 600 includes an application programing interface (API) enabling exchange of decisioning and remediation information with such downstream systems.

Some or all aspects of the integration module 600 as described herein can be implemented via a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, aspects of the integration module 600 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations of the integration module 600 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

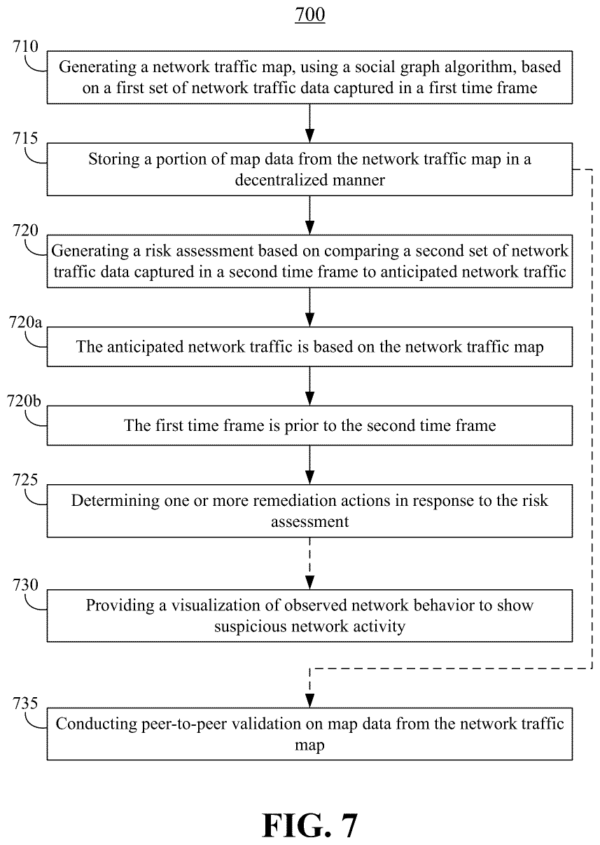

FIG. 7 provides a flow diagram illustrating an example of a method 700 of detecting lateral movement according to one or more embodiments, with reference to components and features described herein including but not limited to the figures and associated description. The method 700 is generally performed within a networked infrastructure environment such as, for example, the networked infrastructure environment 100 (FIG. 1, already discussed). The method 700 (or at least aspects thereof) can generally be implemented in the lateral movement detection system 140 (FIG. 1, already discussed) and/or the lateral movement detection system 200 (FIG. 2, already discussed). More particularly, the method 700 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 700 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 710 provides for generating a network traffic map, using a social graph algorithm, based on a first set of network traffic data captured in a first time frame. The first set of network traffic data includes network traffic data captured from one or more network nodes. In some embodiments, the first set of network traffic data includes data representing one or more of a transaction duration or a volume of data transferred. In some embodiments, the first set of network traffic data is weighted based on one or more of regularity of connections or encryption of traffic.

Illustrated processing block 715 provides for storing a portion of map data from the network traffic map in a decentralized manner. In some embodiments, the portion of map data from the network traffic map is stored in individual nodes and aggregated centrally.

Illustrated processing block 720 provides for generating a risk assessment based on comparing a second set of network traffic data captured in a second time frame to anticipated network traffic, where at block 720a the anticipated network traffic is based on the network traffic map and, at block 720b, the first time frame is prior to the second time frame. In some embodiments, the risk assessment is based on one or more of a relative closeness of the second set of network traffic data the anticipated network traffic or a risk score for riskiness of the second set of network traffic data. In some embodiments, the risk assessment is based on one or more of a predefined risk threshold or a business rule.

Illustrated processing block 725 provides for determining one or more remediation actions in response to the risk assessment. In some embodiments, the one or more remediation actions include one or more of increased observation and sensing activity via node sensors, manipulation of network traffic, manipulation of routing behavior, or invoking an automated firewall rule. In some embodiments, invoking the automated firewall rule includes an alert triggered by observed network behavior that exceeds a policy engine rule or deviates more than a threshold from a map for a particular node. The observed network behavior can include the second set of network traffic data and/or the comparison of the second set of network traffic data with the anticipated network traffic.

In some embodiments, at illustrated processing block 730 a visualization of observed network behavior is provided to show suspicious network activity. The observed network behavior can include the second set of network traffic data and/or the comparison of the second set of network traffic data with the anticipated network traffic. In some embodiments, providing the visualization of observed network behavior includes providing interactive selections for one or more of an identified node, a specific zone, a host type, a network segment, or traffic type. In some embodiments, the interactive selections enable one or more of filtering of network traffic data based on traffic characteristics or prioritizing a type of observed network behavior.

In some embodiments, illustrated processing block 735 provides for conducting peer-to-peer validation on map data from the network traffic map. In some embodiments, the peer-to-peer validation includes exchange of traffic map data between peer nodes based on requests made to each other for their respective maps to validate whether the peer node maps reflect what the requesting node perceives to be an accurate representation of the traffic patterns of that requesting node.

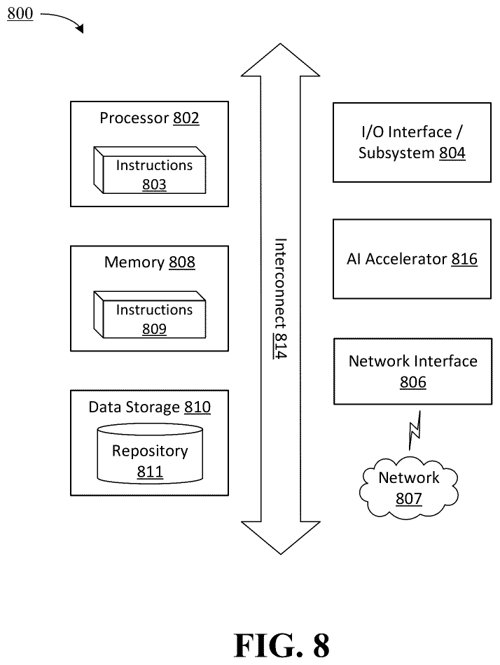

FIG. 8 is a block diagram illustrating an example of an architecture for a computing system 800 for use in a lateral movement detection system according to one or more embodiments, with reference to components and features described herein including but not limited to the figures and associated description. In embodiments, the computing system 800 can be used to implement any of the devices or components described herein, including the lateral movement detection system 140 (FIG. 1), the lateral movement detection system 200 (FIG. 2), the social graph generator 220 (FIG. 2), the comparison engine 230 (FIG. 2), the policy engine 240 (FIG. 2), the dashboard and reporting interface 250 (FIG. 2), the integration module 260 (FIG. 2), the social graph generator 300 (FIG. 3A), the comparison engine 400 (FIG. 4A), the policy engine 450 (FIG. 4B), the dashboard and reporting interface 500 (FIG. 5), the integration module 600 (FIG. 6), and/or any other components of the networked infrastructure environment 100 (FIG. 1). In embodiments, the computing system 800 can be used to implement any of the processes described herein including the method 700 (FIG. 7).

The computing system 800 includes one or more processors 802, an input-output (I/O) interface/subsystem 804, a network interface 806, a memory 808, and a data storage 810. These components are coupled or connected via an interconnect 814. Although FIG. 8 illustrates certain components, the computing system 800 can include additional or multiple components coupled or connected in various ways. It is understood that not all embodiments will necessarily include every component shown in FIG. 8.

The processor 802 can include one or more processing devices such as a microprocessor, a central processing unit (CPU), a fixed application-specific integrated circuit (ASIC) processor, a reduced instruction set computing (RISC) processor, a complex instruction set computing (CISC) processor, a field-programmable gate array (FPGA), a digital signal processor (DSP), etc., along with associated circuitry, logic, and/or interfaces. The processor 802 can include, or be connected to, a memory (such as, e.g., the memory 808) storing executable instructions 809 and/or data, as necessary or appropriate. The processor 802 can execute such instructions to implement, control, operate or interface with any devices, components, features or methods described herein with reference to FIGS. 1, 2, 3A-3C, 4A-4B, 5, 6, and 7. The processor 802 can communicate, send, or receive messages, requests, notifications, data, etc. to/from other devices. The processor 802 can be embodied as any type of processor capable of performing the functions described herein. For example, the processor 802 can be embodied as a single or multi-core processor(s), a digital signal processor, a microcontroller, or other processor or processing/controlling circuit. The processor can include embedded instructions 803 (e.g., processor code).

The I/O interface/subsystem 804 can include circuitry and/or components suitable to facilitate input/output operations with the processor 802, the memory 808, and other components of the computing system 800. The I/O interface/subsystem 804 can include a user interface including code to present, on a display, information or screens for a user and to receive input (including commands) from a user via an input device (e.g., keyboard or a touch-screen device).

The network interface 806 can include suitable logic, circuitry, and/or interfaces that transmits and receives data over one or more communication networks using one or more communication network protocols. The network interface 806 can operate under the control of the processor 802, and can transmit/receive various requests and messages to/from one or more other devices (such as, e.g., any one or more of the devices illustrated herein with reference to FIGS. 1, 2, 3A-3C, 4A-4B, 5, and 6. The network interface 806 can include wired or wireless data communication capability; these capabilities can support data communication with a wired or wireless communication network, such as the network 807, the external network 50 (FIG. 1), the internal network 120 (FIG. 1), and/or further including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a Wi-Fi network or corporate LAN). The network interface 806 can support communication via a short-range wireless communication field, such as Bluetooth, NFC, or RFID. Examples of network interface 806 can include, but are not limited to, an antenna, a radio frequency transceiver, a wireless transceiver, a Bluetooth transceiver, an ethernet port, a universal serial bus (USB) port, or any other device configured to transmit and receive data.

The memory 808 can include suitable logic, circuitry, and/or interfaces to store executable instructions and/or data, as necessary or appropriate, when executed, to implement, control, operate or interface with any devices, components, features or methods described herein with reference to FIGS. 1, 2, 3A-3C, 4A-4B, 5, 6, and 7. The memory 808 can be embodied as any type of volatile or non-volatile memory or data storage capable of performing the functions described herein, and can include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, the memory 808 can store various data and software used during operation of the computing system 800 such as operating systems, applications, programs, libraries, and drivers. The memory 808 can be communicatively coupled to the processor 802 directly or via the I/O subsystem 804. In use, the memory 808 can contain, among other things, a set of machine instructions 809 which, when executed by the processor 802, causes the processor 802 to perform operations to implement embodiments of the present disclosure.

The data storage 810 can include any type of device or devices configured for short-term or long-term storage of data such as, for example, memory devices and circuits, memory cards, hard disk drives, solid-state drives, non-volatile flash memory, or other data storage devices. The data storage 810 can include or be configured as a database, such as a relational or non-relational database, or a combination of more than one database. In some embodiments, a database or other data storage can be physically separate and/or remote from the computing system 800, and/or can be located in another computing device, a database server, on a cloud-based platform, or in any storage device that is in data communication with the computing system 800. In embodiments, the data storage 810 includes a data repository 811, which in embodiments can include data for a specific application. In embodiments, the data repository 811 stores network traffic map data received or generated as described herein).

The interconnect 814 can include any one or more separate physical buses, point to point connections, or both connected by appropriate bridges, adapters, or controllers. The interconnect 814 can include, for example, a system bus, a Peripheral Component Interconnect (PCI) bus, a HyperTransport or industry standard architecture bus, a small computer system interface (SCSI) bus, a universal serial bus (USB), IIC (I2C) bus, or an Institute of Electrical and Electronics Engineers (IEEE) standard 694 bus (e.g., “Firewire”), or any other interconnect suitable for coupling or connecting the components of the computing system 800.

In some embodiments, the computing system 800 also includes an accelerator, such as an artificial intelligence (AI) accelerator 816. The AI accelerator 816 includes suitable logic, circuitry, and/or interfaces to accelerate artificial intelligence applications, such as, e.g., artificial neural networks, machine vision and machine learning applications, including through parallel processing techniques. In one or more examples, the AI accelerator 816 can include hardware logic or devices such as, e.g., a graphics processing unit (GPU) or an FPGA. The AI accelerator 816 can implement any one or more devices, components, features or methods described herein with reference to FIGS. 1, 2, 3A-3C, 4A-4B, 5, 6, and 7.

In some embodiments, the computing system 800 also includes a display (not shown in FIG. 8). In some embodiments, the computing system 800 also interfaces with a separate display such as, e.g., a display installed in another connected device (not shown in FIG. 8). The display can be any type of device for presenting visual information, such as a computer monitor, a flat panel display, or a mobile device screen, and can include a liquid crystal display (LCD), a light-emitting diode (LED) display, a plasma panel, or a cathode ray tube display, etc. The display can include a display interface for communicating with the display. In some embodiments, the display can include a display interface for communicating with a display external to the computing system 800.

In some embodiments, one or more of the illustrative components of the computing system 800 can be incorporated (in whole or in part) within, or otherwise form a portion of, another component. For example, the memory 808, or portions thereof, can be incorporated within the processor 802. As another example, the I/O interface/subsystem 804 can be incorporated within the processor 802 and/or code (e.g., instructions 809) in the memory 808. In some embodiments, the computing system 800 can be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

In some embodiments, the computing system 800, or portion(s) thereof, is/are implemented in one or more modules as a set of logic instructions stored in at least one non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

Embodiments of each of the above systems, devices, components and/or methods, including the networked infrastructure environment 100, the lateral movement detection system 140 (FIG. 1), the lateral movement detection system 200 (FIG. 2), the social graph generator 220 (FIG. 2), the comparison engine 230 (FIG. 2), the policy engine 240 (FIG. 2), the dashboard and reporting interface 250 (FIG. 2), the integration module 260 (FIG. 2), the social graph generator 300 (FIG. 3A), the comparison engine 400 (FIG. 4A), the policy engine 450 (FIG. 4B), the dashboard and reporting interface 500 (FIG. 5), the integration module 600 (FIG. 6), and/or the method 700, and/or any other system, devices, components, or methods can be implemented in hardware, software, or any suitable combination thereof. For example, implementations can be made using one or more of a CPU, a GPU, an AI accelerator, a FPGA accelerator, an ASIC, and/or via a processor with software, or in a combination of a processor with software and an FPGA or ASIC, and/or in one or more modules as a set of program or logic instructions stored in a machine- or computer-readable storage medium such as RAM, ROM, PROM, firmware, flash memory, etc. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C # or the like and conventional procedural programming languages, such as the “C” programming language or similar programming languages.

### ADDITIONAL NOTES AND EXAMPLES

Example M1 includes a computer-implemented method comprising generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

Example M2 includes the method of Example M1, wherein the first set of network traffic data includes data representing one or more of a transaction duration or a volume of data transferred.

Example M3 includes the method of Example M1 or M2, wherein the first set of network traffic data is weighted based on one or more of regularity of connections or encryption of traffic.

Example M4 includes the method of Example M1, M2 or M3, wherein the portion of map data from the network traffic map is stored in individual nodes and aggregated centrally.

Example M5 includes the method of any of Examples M1-M4, further comprising conducting peer-to-peer validation on map data from the network traffic map.

Example M6 includes the method of any of Examples M1-M5, wherein the risk assessment is based on one or more of a relative closeness of the second set of network traffic data the anticipated network traffic or a risk score for riskiness of the second set of network traffic data.

Example M7 includes the method of any of Examples M1-M6, wherein the risk assessment is based on one or more of a predefined risk threshold or a business rule.

Example M8 includes the method of any of Examples M1-M7, wherein the one or more remediation actions include one or more of increased observation and sensing activity via node sensors, manipulation of network traffic, manipulation of routing behavior, or invoking an automated firewall rule.

Example M9 includes the method of any of Examples M1-M8, wherein invoking the automated firewall rule includes an alert triggered by observed network behavior that exceeds a policy engine rule or deviates more than a threshold from a map for a particular node.

Example M10 includes the method of any of Examples M1-M9, further comprising providing a visualization of observed network behavior to show suspicious network activity.

Example M11 includes the method of any of Examples M1-M10, wherein providing the visualization of observed network behavior includes providing interactive selections for one or more of an identified node, a specific zone, a host type, a network segment, or traffic type.

Example M12 includes the method of any of Examples M1-M11, wherein the interactive selections enable one or more of filtering of network traffic data based on traffic characteristics or prioritizing a type of observed network behavior.

Example S1 includes a computing system comprising a processor, and a memory coupled to the processor, the memory comprising instructions which, when executed by the processor, cause the computing system to perform operations comprising generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

Example S2 includes the computing system of Example S1, wherein the first set of network traffic data includes data representing one or more of a transaction duration or a volume of data transferred.

Example S3 includes the computing system of Example S1 or S2, wherein the first set of network traffic data is weighted based on one or more of regularity of connections or encryption of traffic.

Example S4 includes the computing system of Example S1, S2 or S3, wherein the portion of map data from the network traffic map is stored in individual nodes and aggregated centrally.

Example S5 includes the computing system of any of Examples S1-S4, wherein the instructions, when executed, further cause the computing system to perform operations comprising conducting peer-to-peer validation on map data from the network traffic map.

Example S6 includes the computing system of any of Examples S1-S5, wherein the risk assessment is based on one or more of a relative closeness of the second set of network traffic data the anticipated network traffic or a risk score for riskiness of the second set of network traffic data.

Example S7 includes the computing system of any of Examples S1-S6, wherein the risk assessment is based on one or more of a predefined risk threshold or a business rule.

Example S8 includes the computing system of any of Examples S1-S7, wherein the one or more remediation actions include one or more of increased observation and sensing activity via node sensors, manipulation of network traffic, manipulation of routing behavior, or invoking an automated firewall rule.

Example S9 includes the computing system of any of Examples S1-S8, wherein invoking the automated firewall rule includes an alert triggered by observed network behavior that exceeds a policy engine rule or deviates more than a threshold from a map for a particular node.

Example S10 includes the computing system of any of Examples S1-S9, wherein the instructions, when executed, further cause the computing system to perform operations comprising providing a visualization of observed network behavior to show suspicious network activity.

Example S11 includes the computing system of any of Examples S1-S10, wherein providing the visualization of observed network behavior includes providing interactive selections for one or more of an identified node, a specific zone, a host type, a network segment, or traffic type.

Example S12 includes the computing system of any of Examples S1-S11, wherein the interactive selections enable one or more of filtering of network traffic data based on traffic characteristics or prioritizing a type of observed network behavior.

Example C1 includes at least one computer readable storage medium comprising a set of instructions which, when executed by a computing device, cause the computing device to perform operations comprising generating a network traffic map, using a social graph algorithm, based on a first set of network traffic data captured in a first time frame, storing a portion of map data from the network traffic map in a decentralized manner, generating a risk assessment based on comparing a second set of network traffic data captured in a second time frame to anticipated network traffic, wherein the anticipated network traffic is based on the network traffic map, and wherein the first time frame is prior to the second time frame, and determining one or more remediation actions in response to the risk assessment.

Example C2 includes the at least one computer readable storage medium of Example C1, wherein the first set of network traffic data includes data representing one or more of a transaction duration or a volume of data transferred.

Example C3 includes the at least one computer readable storage medium of Example C1 or C2, wherein the first set of network traffic data is weighted based on one or more of regularity of connections or encryption of traffic.

Example C4 includes the at least one computer readable storage medium of Example C1, C2 or C3, wherein the portion of map data from the network traffic map is stored in individual nodes and aggregated centrally.

Example C5 includes the at least one computer readable storage medium of any of Examples C1-C4, wherein the instructions, when executed, further cause the computing device to perform operations comprising conducting peer-to-peer validation on map data from the network traffic map.

Example C6 includes the at least one computer readable storage medium of any of Examples C1-C5, wherein the risk assessment is based on one or more of a relative closeness of the second set of network traffic data the anticipated network traffic or a risk score for riskiness of the second set of network traffic data.

Example C7 includes the at least one computer readable storage medium of any of Examples C1-C6, wherein the risk assessment is based on one or more of a predefined risk threshold or a business rule.

Example C8 includes the at least one computer readable storage medium of any of Examples C1-C7, wherein the one or more remediation actions include one or more of increased observation and sensing activity via node sensors, manipulation of network traffic, manipulation of routing behavior, or invoking an automated firewall rule.

Example C9 includes the at least one computer readable storage medium of any of Examples C1-C8, wherein invoking the automated firewall rule includes an alert triggered by observed network behavior that exceeds a policy engine rule or deviates more than a threshold from a map for a particular node.

Example C10 includes the at least one computer readable storage medium of any of Examples C1-C9, wherein the instructions, when executed, further cause the computing device to perform operations comprising providing a visualization of observed network behavior to show suspicious network activity.

Example C11 includes the at least one computer readable storage medium of any of Examples C1-C10, wherein providing the visualization of observed network behavior includes providing interactive selections for one or more of an identified node, a specific zone, a host type, a network segment, or traffic type.

Example C12 includes the at least one computer readable storage medium of any of Examples C1-C11, wherein the interactive selections enable one or more of filtering of network traffic data based on traffic characteristics or prioritizing a type of observed network behavior.

Example A1 includes an apparatus comprising means for performing the method of any of Examples M1-M12.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A computer-implemented method comprising:
generating a network traffic map, using a social graph algorithm, based on a first set of network traffic data captured in a first time frame;
storing a portion of map data from the network traffic map in a decentralized manner;
generating a risk assessment based on comparing a second set of network traffic data captured in a second time frame to anticipated network traffic, wherein the anticipated network traffic is based on the network traffic map, and wherein the first time frame is prior to the second time frame; and
determining one or more remediation actions in response to the risk assessment.

2. The method of claim 1, wherein the first set of network traffic data includes data representing one or more of a transaction duration or a volume of data transferred.

3. The method of claim 1, wherein the first set of network traffic data is weighted based on one or more of regularity of connections or encryption of traffic.

4. The method of claim 1, wherein the portion of map data from the network traffic map is stored in individual nodes and aggregated centrally.

5. The method of claim 4, further comprising conducting peer-to-peer validation on map data from the network traffic map.

6. The method of claim 1, wherein the risk assessment is based on one or more of a relative closeness of the second set of network traffic data the anticipated network traffic or a risk score for riskiness of the second set of network traffic data.

7. The method of claim 1, wherein the risk assessment is based on one or more of a predefined risk threshold or a business rule.

8. The method of claim 1, wherein the one or more remediation actions include one or more of increased observation and sensing activity via node sensors, manipulation of network traffic, manipulation of routing behavior, or invoking an automated firewall rule.

9. The method of claim 8, wherein invoking the automated firewall rule includes an alert triggered by observed network behavior that exceeds a policy engine rule or deviates more than a threshold from a map for a particular node.

10. The method of claim 1, further comprising providing a visualization of observed network behavior to show suspicious network activity.

11. The method of claim 10, wherein providing the visualization of observed network behavior includes providing interactive selections for one or more of an identified node, a specific zone, a host type, a network segment, or traffic type.

12. The method of claim 11, wherein the interactive selections enable one or more of filtering of network traffic data based on traffic characteristics or prioritizing a type of observed network behavior.

13. A computing system comprising:
a processor; and
a memory coupled to the processor, the memory comprising instructions which, when executed by the processor, cause the computing system to perform operations comprising:
generating a network traffic map, using a social graph algorithm, based on a first set of network traffic data captured in a first time frame;
storing a portion of map data from the network traffic map in a decentralized manner;
generating a risk assessment based on comparing a second set of network traffic data captured in a second time frame to anticipated network traffic, wherein the anticipated network traffic is based on the network traffic map, and wherein the first time frame is prior to the second time frame; and
determining one or more remediation actions in response to the risk assessment.

14. The computing system of claim 13, wherein the portion of map data from the network traffic map is stored in individual nodes and aggregated centrally, and wherein the instructions, when executed, cause the computing system to perform further operations comprising conducting peer-to-peer validation on map data from the network traffic map.

15. The computing system of claim 13, wherein the risk assessment is based on one or more of a relative closeness of the second set of network traffic data the anticipated network traffic, a risk score for riskiness of the second set of network traffic data, a predefined risk threshold or a business rule.

16. The computing system of claim 13, wherein the one or more remediation actions include one or more of increased observation and sensing activity via node sensors, manipulation of network traffic, manipulation of routing behavior, or invoking an automated firewall rule, and wherein invoking the automated firewall rule includes an alert triggered by observed network behavior that exceeds a policy engine rule or deviates more than a threshold from a map for a particular node.

17. At least one computer readable storage medium comprising a set of instructions which, when executed by a computing device, cause the computing device to perform operations comprising:
generating a network traffic map, using a social graph algorithm, based on a first set of network traffic data captured in a first time frame;
storing a portion of map data from the network traffic map in a decentralized manner;
generating a risk assessment based on comparing a second set of network traffic data captured in a second time frame to anticipated network traffic, wherein the anticipated network traffic is based on the network traffic map, and wherein the first time frame is prior to the second time frame; and
determining one or more remediation actions in response to the risk assessment.

18. The at least one computer readable storage medium of claim 17, wherein the portion of map data from the network traffic map is stored in individual nodes and aggregated centrally, and wherein the instructions, when executed, cause the computing device to perform further operations comprising conducting peer-to-peer validation on map data from the network traffic map.

19. The at least one computer readable storage medium of claim 17, wherein the risk assessment is based on one or more of a relative closeness of the second set of network traffic data the anticipated network traffic, a risk score for riskiness of the second set of network traffic data, a predefined risk threshold or a business rule.

20. The at least one computer readable storage medium of claim 17, wherein the one or more remediation actions include one or more of increased observation and sensing activity via node sensors, manipulation of network traffic, manipulation of routing behavior, or invoking an automated firewall rule, and wherein invoking the automated firewall rule includes an alert triggered by observed network behavior that exceeds a policy engine rule or deviates more than a threshold from a map for a particular node.
